(19) United States
(12) Patent Application Publication
(10) Pub. No.: US 2009/0091457 A1
(43) Pub. Date: Apr. 9, 2009

(54) Multilayer Security Seal

(75) Inventors: Tobias Kresse, Hamburg (DE); David Tuffe, Hamburg (DE); Claus Grobe, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA AG, Hamburg (DE)

(21) Appl. No.: 12/212,132

(22) Filed: Sep. 17, 2008

Related U.S. Application Data
(63) Continuation-in-part of application No. 11/867,099, filed on Oct. 4, 2007.

(30) Foreign Application Priority Data
Jul. 22, 2008 (DE) 10 2008 034268.8

(51) Int. Cl. G08B 13/14

(52) U.S. Cl. 340/572.8

(57) ABSTRACT

The present invention relates to a multilayer security seal comprising a carrier and an adhesive layer arranged on the entire area underneath the carrier, the following layers being arranged between carrier and adhesive layer in any case: a) a first layer—marking layer—not applied to the entire area, b) a second layer—contrast layer—applied to the entire area. It is proposed that an individual identifier, which is at least partly provided in the composite, be contained for the purpose of verification.

### CROSS-REFERENCE TO RELATED APPLICATIONS

This patent application is a continuation-in-part of U.S. patent application Ser. No. 11/867,099 entitled Muti-Layer Adhesive Closure, filed on Oct. 4, 2007 and claiming Priority of DE 10 207 041 474.0 filed Aug. 31, 2007.

### BACKGROUND OF THE INVENTION

(1) Field of the Invention

The present invention relates to a multilayer security seal according to the precharacterizing clause of claim 1 and to methods for the verification of a multilayer security seal according to the precharacterizing clause of claim 18.

(2) Description of Related Art

The prior art discloses various multilayer security seals, particularly in the use as adhesive closures which provides a proof of opening for a pack, that is to say indicate irreversibly whether, in the case of a package secured by means of such an adhesive closure, a first attempt at opening has already been made. Such a proof is imperative in the logistic chain in order to ensure that the respective pack, for example a package or a transport pallet, has not been opened without authority in the meantime.

Such a security seal is shown, for example, by DE 100 30 596 A1 in the form of a multilayer adhesive tape. The adhesive closure firstly has a carrier based on an oriented thermoplastic film, to the underside of which a primer layer that is not applied over the entire area is applied and anchored to the thermoplastic film. The entire surface of the primer layer and the free thermoplastic film surface are hidden with a first, in particular coloured, contrast layer. This first contrast layer is in this case anchored better to the primer layer than to the thermoplastic film. In the product described in DE 100 30 596 A1, the entire surface of the first contrast layer is in turn hidden with a second contrast layer, which is anchored better to the first contrast layer than the first contrast layer to the thermoplastic film. The second contrast layer is followed by a contact adhesive compound, which is anchored better to the second contrast layer than the first contrast layer to the thermoplastic film.

If such a security seal known from the prior art is opened for the first time, then, depending on the anchoring of the respective layers to one another, a rupture in each case occurs where the anchoring between two layers is the lowest. The layers between which this rupture occurs in this case depend on whether it is a primed region or not. The primer layer, not applied over the entire surface, has previously been applied to the carrier in the form of a line of text, such as “opened”, for example, so that this text now appears and indicates the first opening. Even if the layers are adhesively bonded to one another again, the line of text remains detectable.

A further security seal known from the prior art is shown by DE 101 40 491 A1 in the form of a multilayer label. In the label described there, a proof of first opening is also implemented by a functional sequence of layers.

One disadvantage of such a security seal is, however, that it can be removed completely from the object to be secured and if necessary can be replaced by a new closure. A new adhesive closure can once more be an adhesive closure which contains a proof of first opening but an adhesive closure merely appearing similar without such a proof of first opening can also be chosen. Within the context of the logistic chain, such a manipulation draws attention only at the end of the logistic process, that is to say as a rule at the end customer. It is thus no longer possible to detect where such a manipulation has taken place, in order to trace those responsible.

The present invention is therefore based on the problem of specifying a multilayer security seal which makes manipulation within the logistic chain more difficult. In addition, improved security seals for the verification of articles are sought, as well as verification methods based on such seals.

The invention solves the problem explained above in a multilayer security seal having the features of the precharacterizing clause of claim 1 by means of the features of the characterizing part of claim 1. An equivalent solution is provided by a method according to claim 16. Preferred refinements and developments form the subject-matter of the respective subclaims.

### BRIEF SUMMARY OF THE INVENTION

According to the invention, the solution to the problem is achieved in that the multilayer security seal, in addition to the proof of first opening, also contains an individual identifier for the purpose of verification in a novel manner. During a logistic process, it is thus possible to monitor, for example, whether this is still the original security seal or whether this has been replaced in the meantime. With the coupling to the proof of first opening, manipulation of the secured object, such as a pack, therefore itself also remains ruled out. The individual identifier can in this case contain, for example, individual information such as origin, manufacture, type, marketing route and/or serial number of the object to be secured or of the adhesive closure itself. In particular, the identifier can be formed as an alphanumeric symbol, bar code (1-dimensional), matrix code (2-dimensional) or the like.

In order to increase the level of security of security seals still further for specific applications, in particular when they are used for the verification of the authenticity of an article, provision is made in a preferred refinement for the individual identifier to be composed of a hidden part and an exposed part. At least one part of this individual identifier is contained in the product in such a way that this part is present non-detectably, that is to say hidden, when in the adhesively bonded and intact state. A forger can therefore make a copy of the complete individual identifier only when the hidden part of the identifier is exposed, which is not possible without irreversible rupture of the security seal and can therefore be detected clearly. During the entire logistic process, it is thus possible to monitor whether this is still the original security seal or whether this has been replaced or opened in the meantime. With the coupling to the proof of first opening, manipulation of the secured object, such as a pack, is therefore itself also ruled out. The individual identifier—irrespective of whether arranged to be hidden or exposed—can, for example, as already previously described, contain individual information such as origin, manufacture, type, marketing route and/or serial number of the object to be secured or of the adhesive closure itself. In particular, the identifier can be formed as an alphanumeric symbol, bar code (1-dimensional), matrix code (2-dimensional) or the like. If very high security is to be ensured, it is also possible for individually calculated computer-generated holograms to be contained as an individual identifier. With respect to the configuration of such computer-generated holograms, reference is made in particular to EP 1 377 883 B1.

The identifier or else code can in particular comprise a number of alphanumeric symbols. In this case, use is preferably made of the largest possible group of numbers. It can be provided completely exposed in the security seal and be repeated completely as a hidden identifier in the seal. It can also and specifically preferably also comprise a hidden and an exposed part. Particularly advantageous for highest possible security is a correlation between exposed part and hidden part of the identifier. The correlation can be implemented, for example, by a repetition of the identifier, a completion of the two parts or else suitable encryption. In this case, the hidden part of the identifier can be linked with the exposed part. Recommended for this purpose is, for example, a logical combination via an algorithm or else that the identifier is given by all the digits, that is to say the concatenation of the hidden part of the identifier and of the exposed part of the identifier. However, it is also conceivable that only the exposed part of the identifier or only the hidden part of the identifier is taken from a group of numbers which is as large as possible, but the respective other is taken from a restricted set of combinations of alphanumeric symbols. The exposed and the hidden identifier can be chosen in such a way that their first combination leads to the complete identifier. The hidden identifier can repeat part of the exposed identifier. The exposed identifier can be the repetition of part of the hidden identifier.

The hidden part of the identifier can be applied to or incorporated in one layer or a plurality of layers within the adhesive closure. This part of the identifier is hidden by at least one layer from one side, preferably the side facing away from the background of the adhesive bond, in such a way that this part of the identifier cannot be detected through this at least one layer.

However, it is particularly advantageous to apply the identifier between two other layers, for example between the carrier and the contrast layer, that is to say beside the marking layer that is not applied over the entire area. Such an arrangement has the advantage that the identifier can be arranged so as to be hidden and possibly even concealed, so that imitation is made more difficult.

The identifier, in particular the exposed part of the identifier, can be applied to the carrier or any other layer of the security seal, in any case so that it can be read without making any further changes to the security seal. Provision can therefore also be made for the identifier to be arranged within a layer. A configuration of this type is, for example, advantageous for the introduction of a computer-generated hologram. A hologram of this type can, for example, be written into the carrier or another storage layer, possibly additionally provided, by means of a laser lithograph. The exposed part of the identifier is preferably located above the carrier of the security seal.

Furthermore, the identifier can be designed in such a way that it is possible for the user to read the identifier without further aids. Reading can be carried out by eye or by a machine. It is likewise possible to design the identifier in such a way that it is possible only with the support of an aid such as a magnifying glass or by illuminating with UV light or the like. In these cases, too, the identifier can be provided in such a way that it can be read by eye and/or machine, in any case while using the appropriate aid. These statements apply independently of each other to the exposed and to the hidden part of the identifier.

According to a preferred design, a first check relating to the authenticity or other details of the article is already possible for a tester by using the exposed part of the identifier. For this quick test, damaging the security seal is not necessary. The combination with the hidden part of the identifier then permits a more extensive test. However, it is also possible to configure the complete identifier such that the bare knowledge of the exposed part still does not enable any statements relating to the authenticity or other details about the article; instead, this is possible only in combination with the hidden part.

The proof of first opening in the security seal according to the invention, as is known from the prior art (DE 101 40 491 A1), can be formed in its simplest embodiment by a first layer on the carrier—marking layer—not applied to the entire area, and a second layer—contrast layer—covering the entire area of the free surface of the carrier. In this case, the carrier can be formed, for example, as an oriented thermoplastic film of oriented HDPE, PVC, PET, monoaxially oriented polypropylene or biaxially oriented polypropylene and transparent, translucent or coloured, in particular opaquely coloured. In a preferred refinement, the marking layer is an adhesion promoter or a primer. This is very well anchored to the carrier. The contrast layer, on the other hand, is anchored better to the marking layer (primer) than to the carrier. Underneath the contrast layer there is additionally the adhesive layer, which is, for example, a contact adhesive compound applied to the entire area. The adhesive layer in turn is anchored better to the contrast layer than the contrast layer to the carrier. Arranged underneath the carrier and preferably above the adhesive layer is that part of the identifier which is hidden.

An alternative refinement of the proof of first opening consists for example in forming the marking layer as a partial release layer. In addition, further methods and refinements relating to the partial setting of the adhesive properties required for a proof of first opening are known to those skilled in the art from the various documents. In particular, reference is made in this regard to EP 341 699 B1, to U.S. Pat. No. 5,153,042, to U.S. Pat. No. 5,582,887 and to U.S. Pat. No. 5,633,058, of which the disclosure content is incorporated by reference. In such configurations, that part of the identifier which is hidden is also arranged underneath the carrier and preferably above the adhesive layer.

In a first refinement according to the invention, when the security seal according to the invention is removed from the surface of a pack, the security seal leaves an identification on the pack, in that the in particular coloured contrast layer separates from the carrier, while regions which are well anchored to the carrier surface by means of the marking layer (primer) are detached from the surface of the pack with the carrier. The region of the contrast layer which was anchored strongly to the carrier surface by means of the marking layer remains on the carrier surface. The identification that can be detected on the pack thus exhibits the inverse image of the marking layer that does not cover the entire area. If the marking layer was applied as a line of text or other type of identification, the inverse of this identification thus becomes visible. The identification can, for example, read “open”. In addition, the hidden part of the identifier is exposed during the removal.

In a second refinement according to the invention, when the security seal according to the invention is removed from the surface of a pack, the security seal leaves an identification on the pack, in that the in particular coloured contrast layer remains on the carrier and is detached from the pack together with the said carrier while regions which are not anchored or anchored only slightly to the carrier surface by means of a marking layer (release) are detached from the carrier and remain on the surface of the pack. The region of the contrast layer which was anchored only slightly or not at all to the carrier surface by means of the marking layer remains on the pack. The identification that can be detected on the pack thus exhibits the image of the marking layer not applied to the entire area. If the marking layer was applied as a line of text or other type of identification, this identification thus becomes visible. In addition, the hidden part of the identifier is also exposed here during the removal.

Besides the marking layer and the contrast layer, further layers, in particular further contrast layers, can also be provided. For the refinement in this regard, reference is made to the prior art. In particular, the disclosure content of DE 100 30 596 A1 is also incorporated by reference for this purpose. In particular, there can be one layer above part of the identifier in order to prevent this part of the identifier being detectable through it. However, this layer, possibly in conjunction with further layers, can be detached from the layer composite which carries the hidden part of the identifier, so that the latter is exposed and can then also be read.

In a preferred refinement, at least the exposed part of the identifier is implemented as a machine-readable identifier. This offers the advantage that, within the logistic chain, for example during automatic sorting, automatic verification of the security seal can be carried out. As a result, a manual check, which thus requires expenditure on personnel, can be avoided. Depending on the configuration of the identifier, however, manual verification can also be carried out additionally or as an alternative to the automatic verification. In particular, verification of this type can also be provided additionally or alternatively by the final recipient of the security seal.

In one refinement, the multilayer security seal is designed in such a way that the identifier, in particular both its hidden and its exposed part independently of one another, is not visible without aids and/or with the naked eye. The identifier can be found and read only by means of suitable aids. The concealed arrangement of an identifier can be provided, for example, by this being applied with a fluorescent dye and thus not being visible under daylight (white light). Instead, it requires a specific light source, specifically UV light here, in order to be able to read the identifier. In a preferred embodiment, provision is made for the marking layer to contain such a fluorescent dye. In this case, it is at least possible to check via the fluorescence whether the multilayer security seal contains an appropriate proof of first opening.

In a preferred refinement, provision is made for part of the identifier to be encoded in any case. By means of encoding, it is possible to ensure that valid identifiers cannot be produced arbitrarily. Instead, by means of subsequent verification of the encoding, it is also possible to ensure that the identifier is an authentic identifier or a copy. Such a refinement is advantageous in particular when the verification is carried out centrally, since it is thus possible to ensure that the key for the encoding and decoding can be used without authority. The central verification can be carried out, for example, via modern communications paths, such as networking registration devices with the central facility, mobile radio, etc.

A key, which is kept secret within the encoding and decoding method, makes it possible for an algorithm which is known per se and not kept secret to carry out the encoding and decoding operation. In the sense of this invention, symmetrical and asymmetrical algorithms can be used. According to the invention, it is particularly preferred to use symmetrical algorithms, such as in particular AES, 3DES, DES. Such algorithms are already used to a wide extent nowadays in the area of financial transactions, the encryption of electronic messages and in the region of cable-free communications technology.

The verification of an encoded identifier is particularly simple in particular when the identifier, in addition to the encoded part, contains an unencoded part which is coupled with the encoded part. With the aid of the key to be kept secret, either the encrypted part is decrypted and compared with the unencoded part of the identifier or, alternatively, the unencoded part is encrypted and the result is compared with the encoded part of the identifier. The second, alternative method is the preferred one. It permits the encoded part of the identifier to be shortened and therefore, whilst taking the need for security into account, the amount of data or the total length of the identifier on the adhesive closure to be reduced. A similar principle is known, for example from the digital signature.

Besides the key, the intermediate result of the verification, that is to say the result of the encoding or decoding, is kept secret from the user and other external accesses within such an encryption method. The user is notified only about the result of the comparison as a yes/no answer via a possibly public communications route. Otherwise, a generator for valid identifiers would be provided.

Particular preference is given to a refinement in which, if part of the identifier is hidden and a further part is provided exposed and also encoded and unencoded information is contained, the encoded part of the information is contained in the exposed part of the identifier and/or in the hidden part. Furthermore, the unencoded part can contain the information in the exposed part of the identifier and/or in the hidden part. In any case, that is to say even when the complete identifier is provided in hidden form, verification of the number is only possible after the closure seal has been opened and the seal has therefore been broken irreversibly.

It is also advantageous to provide part of the hidden identifier as a key for decoding the remaining part of the identifier. That part of the identifier which represents the key is in this case part of the hidden part of the identifier. The user can therefore then check for himself whether the identifier that is present is valid by opening the closure seal and exposing the key.

As is known in principle from the prior art, the multilayer security seal can be formed as a security label or else as an adhesive tape. If it is an adhesive tape, a plurality of individual identifiers should be provided on the adhesive tape. These should be arranged in particular at regular intervals, in order to be able to employ the adhesive tape in any desired length.

In a method according to the invention, the intactness of a pack or an article is verified. This means that it is ensured whether a manipulation to a pack has been carried out. To this end, it is firstly determined whether the pack and the security seal securing the pack are intact. In particular, whether the adhesive closure indicates first opening is therefore inspected here. Furthermore, the security seal itself is inspected with regard to its authenticity. It is therefore determined whether an original security seal is arranged on the pack or whether a manipulation with regard to the security seal has been carried out. Only when both tests have been completed successfully is the intactness of the pack or the originality of the article verified. The order of the individual test steps is not critical in this method. However, it is recommended to check the security seal for intactness first, since this check can be carried out generally more quickly and more simply than the verification of the security seal.

In order to verify the security seal, its individual identifier is read and checked. The check can be made for example by means of a comparison with a reference value. The reference value can be stored in a database, for example, or else contained in the security seal itself, for example as a hidden part of the identifier. This is recommended in particular when part of the identifier is encoded in any case. If the encoded and the unencoded part are additionally coupled with each other, the verification can be carried out by decrypting the encoded part or preferably by encrypting the unencoded part and comparing the two parts of the identifier. In a preferred refinement of the method, in order to verify the authenticity of the security seal, the latter is opened (the seal is broken) and the hidden part of the identifier is exposed.

The verification of the identifier and in particular the encryption and/or decryption of an encoded identifier and comparison of the two parts is preferably carried out centrally in such a method, in order to keep the level of dissemination of reference values and/or the encryption codes as small as possible. The request for verification can be carried out for example by means of modern mobile communications services via the Internet, mobile telephone or the like.

However, in the case of security seals according to the invention, the verification of the identifier is even more simply possible if the procedure is carried out in accordance with a further embodiment. According to the latter, the complete identifier can be detected in the sealed state. In addition, the security seal contains part of this identifier in hidden form, for example the last three digits of the code. The user can then check himself and without accessing further databases or the like whether the security seal and therefore the secured article is original or not. According to this verification concept, the security seal can be viewed as original in the event of agreement between the identifier parts.

In particular, provision can also be made for an additional identifier to be read which gives information as to whether the security seal, in particular therefore a security seal that has not yet been opened, contains a proof of first opening. Such an identifier and/or, depending on the configuration of the security seal, also the individual identifier is read in particular from the marking layer.

In a preferred refinement, the verification of the intactness of the pack or the originality of an article can be carried out automatically. In this case, an inspection is made automatically to check that no first opening has been made. In particular, in this case an inspection is carried out to see whether the object secured with a multilayer security seal is secured with an original security seal. For this purpose, it is necessary for the object to be secured to be equipped with a multilayer security seal, as has been described previously, which in particular contains a machine-readable identifier. If this is an encoded identifier, automatic encryption/decryption of the identifier and comparison of the identifier with a reference value is in particular also carried out. In this case, as has been described previously, the reference value can likewise be read from the multilayer security seal. Alternatively, the reference value can also be stored in the system. If, during the automatic verification, a deviation from the intended values, that is to say for example a first opening which has already been indicated or an unoriginal security seal is detected, in a preferred refinement of the method an appropriate signal is given. This signal can be provided, for example, acoustically or visually by means of an identification of the respective object. Alternatively or additionally to this, the affected object is preferably sorted out directly.

Further details, features, objects and advantages of the present invention will be explained in more detail below using a drawing of a preferred exemplary embodiment. In the drawing:

### BRIEF DESCRIPTION OF THE SEVERAL VIEWS OF THE DRAWINGS

FIG. 1 shows a three-dimensional illustration of a carton on which the security seal according to the invention is stuck,

FIG. 2 shows an enlarged detail from the illustration in FIG. 1 with a security seal stuck on and partly detached from the carton surface,

FIG. 3 shows a sectional drawing of the security seal according to the invention in its original and sealed form,

FIG. 4 shows a sectional drawing similar to FIG. 3 but which shows the relationships of the individual layers when the security seal is pulled off the carton for the first time.

### DETAILED DESCRIPTION OF THE INVENTION

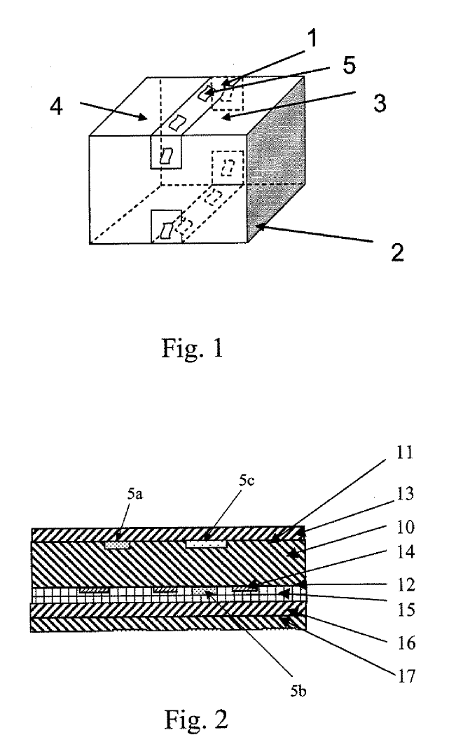

FIG. 1 shows a preferred configuration of a security seal in the form of an adhesive label 1, which is used to secure and close an object such as a carton 2. The carton 2 has upper top flaps 3, 4, which are folded down in order to close the carton 2 and meet on a line 6. As usual, the adhesive label 1 has been stuck over the line 6 on the upper and lower side of the carton 2 and in each case stuck down to the ends of the carton 2 in order to hold the top flaps 3, 4 down.

In order to reach the contents of the carton 2 without the attempt at opening being noticed later, the adhesive label 1 in the region of the line 6 has to be removed in order then to be able to fold up the top flaps 3, 4. If the adhesive label 1 used is a commercially available adhesive label, after the contents have been removed from the carton 2 and the adhesive label 1 has been stuck down carefully again, it is not possible to see that the adhesive label 1 has earlier already been detached once. However, even when use is made of an adhesive label with proof of opening, known from the prior art, there is the danger that the said label will be detached completely from the carton 2 and the carton 2 will then be stuck down with a new adhesive label.

The present multilayer security seal, shown here in a configuration as an adhesive label 1, therefore additionally has an individual identifier 5, by means of which the security seal can be identified and therefore also verified. Unnoticed opening and closing of the carton 2 is therefore just as little possible as unnoticed opening with subsequent replacement of the adhesive label. An individual identifier 5 can be provided many times spaced apart from one another, in particular in a configuration of the security seal in the form of an adhesive tape. In particular, these identifiers 5 can then be provided at regular intervals. In this case, the plurality of individual identifiers 5 should in each case be formed differently from one another, in order to make the forgery of a valid identifier more difficult.

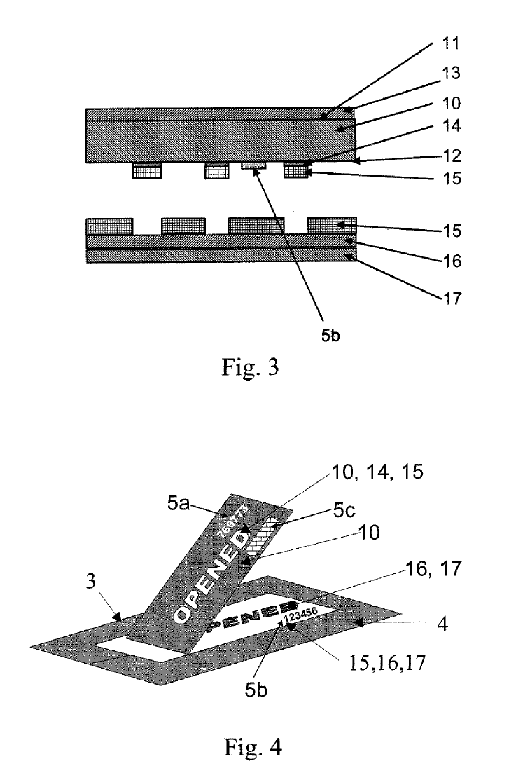

FIGS. 2, 3 show the structure of the adhesive label 1 with the function of the proof of opening in a schematic illustration. Of course, however, signals other than the one shown can also be used. The adhesive label 1 has a preferably transparent thermoplastic film as carrier 10. The carrier is formed in such a way that it has adequate internal strength which satisfies the requirements with regard to proof of first opening.

Applied to the upper side 11 of the carrier 10 (the side facing away from the adhesive layer) is the exposed part of the identifier 5a, as well as here and preferably an area 5cwhich is opaque. The hidden part of the identifier 5b is provided between the carrier 10 and an adhesive layer 17.

On the lower surface 12 of the carrier 10, a transparent primer layer that does not cover the entire area is applied in a first operation as a marking layer 14. In this case, the marking layer 14 is arranged on the carrier surface 12 in such a way that the result is a line of text which, in the event that the adhesive tape 1 is detached from the carton 2, can be detected on the latter.

In a second step, a first contrast layer 15 is applied to the entire area of the marking layer 14 and the remaining carrier surface 12. Here and preferably, the contrast layer 15 consists of a coloured material. In a third step, a further contrast layer 16 is applied to the entire area of the contrast layer 15. The contrast layer 16 consists of a coloured or colourless material. The colour and the colour density of the layers 15 and 16 are chosen here such that they offer sufficient colour contrast in relation to the remaining carton material colours. However, for containers of other types and other colours, other appropriately adapted colours can also be used.

Next, an adhesive layer 17 which ensures adequate adhesive bonding security on the carton surface is applied to the contrast layer 16.

The subsequently hidden part 5b of the identifier 5 can be introduced in a separate process step and preferably in line on, in and/or between the remaining partial or full-area layers underneath the carrier 10. Advantageously, the subsequently hidden part 5b of the identifier 5 is introduced during the production of the marking layer 14, for example jointly with the latter and by an identical method or separately, for example by thermal transfer, inkjet printing or other methods known to those skilled in the art. Optionally, the subsequently hidden part 5b of the identifier 5 can be introduced into the security seal as part of the contrast layer 15 or jointly with the contrast layer 15 by the same or another method.

In accordance with this example, the marking layer 14 adheres relatively strongly to the carrier surface 12. The contrast layer 15 adheres only relatively weakly to the carrier surface 12 but relatively strongly to the marking layer 14. The adhesion of the contrast layer 15 to the carrier surface 12 is lower than the adhesion of the contrast layer 16 to the adhesive layer 17. The adhesion of the contrast layer 15 to the contrast layer 16 is higher than the adhesion of the marking layer 14 to the carrier surface 12.

On the upper side 11 of the film carrier 10, as in the present case, a preferably transparent release layer 13 which adheres relatively strongly to the surface 11 can be applied. This is recommended in particular in a configuration of the security seal as an adhesive tape. The adhesion of the release layer 13 to the adhesive compound layer 17 is low, so that an adhesive tape wound up into a roll can be unwound without separation of the contrast layer 15 from the film surface 12 occurring.

When the security seal according to FIG. 2 is stuck to a surface, the uniform colour of the colour layers 15 and 16, respectively, is visible because of the preferred transparency of the release layer 13 and the film carrier 10 and also of the marking layer 14.

When the security seal—as shown in FIG. 4—is detached from the carton surface 3, 4, it separates in accordance with FIG. 3. In the process, in the region in which the contrast layer 15 is in direct contact with the carrier surface 12, the contrast layer 15 together with the contrast layer 16 and the adhesive layer 17 separates from the carrier 10 and remains on the carton surface 3, 4. In the region in which the marking layer 14 is located, the contrast layer 15 separates from the contrast layer 16. The adhesive layer 17 remains on the carton surface 3, 4 with the contrast layer 16, and the contrast layer 15 remains on the carrier film 10. The word “OPENED” is visible as a line of text on the carton surface 3, 4 and as a coloured line of text on the carrier 10. In addition, the hidden part 5b of the identifier 5 is exposed, so that verification can then be carried out.

When the detached part of the security seal is replaced, the line of text “OPENED” remains visible, since the layer of air at the interface between contrast layer 15 and contrast layer 16 forms a change in the refraction of light as compared with the previous structure without a layer of air. Furthermore, the line of text on the carrier film 10 can no longer be laid congruently on the free line of text on the carton surface, as a result of the carrier 10 being deformed during the application and detachment.

FIG. 4 reveals the fact that the hidden part 5b of the individual identifier 5 can be formed as part of the line of text of the proof of first opening, although this can also be provided separately from the proof of first opening. The identifier 5b is here implemented beside the partially applied marking layer 14 between the carrier 10 and the contrast layer 12. In this case, the identifier can be applied with a special ink, for example a fluorescent ink, and thus be legible only under specific lighting conditions (UV light). In any case, however, the exposed part of the identifier is applied in such a way that it is visible even without aids. The visibility is in this case provided by transparency of the carrier 10.

The marking layer 14 itself can even be provided as an individual identifier 5. If the marking layer 14 additionally contains a fluorescent dye, the individual identifier 5 can be read under suitable lighting conditions without destruction of the security seal. Alternatively, provision can also be made for the marking layer 14 to contain an additional identifier to the individual identifier 5. By means of this additional identifier, it is then possible to determine at any time whether the security seal contains the proof of first opening. This additional identifier can likewise be achieved by means of a fluorescent dye in the marking layer 14.

Furthermore, the identifier 5 can be formed as a machine-readable identifier. Depending on the application, provision can also be made for the individual identifier 5 to be exclusively machine-readable, that is to say legible only with suitable technical aids. This is the case in particular when the identifier is formed as a bar code or as a computer-generated hologram.

The individual identifier 5 shown in detail in FIG. 4 is composed, according to the present example, of two parts 5a and 5b . The first part, the exposed part 5a , contains the alphanumeric sequence of numbers “760773”. This sequence of numbers is an encoded sequence of numbers. The second part of the identifier 5, the hidden part 5b , contains the sequence of alphanumeric numbers “123456”. This part of the identifier 5 is not encoded in this example and corresponds, for example, to a serial number. Before the introduction of the identifier 5 into the adhesive closure, in the present case the first part of the identifier 5, that is to say the serial number here, is used to calculate the second part of the identifier 5 by means of an encryption code. The contents of the two parts of the identifier 5 are thus coupled, specifically contain the same information in the present case, once in encoded form and once in unencoded form. For the purpose of verification of the adhesive closure, both parts of the code can thus be read and, following decryption of the second part of the identifier 5, can be compared with each other. Since the encryption and decryption code is not generally known, however, it is virtually impossible for forgers to generate individual valid codes. The security can additionally be increased further by each identifier 5 being used only once and stored in a database. Following verification, this identifier 5 can then be stored as invalid for the future, so that a further use of this identifier 5 on a new security seal can be identified as a forgery.

A particularly advantageous variant (not shown) relating to verification relates to at least part of the exposed identifier 5a being repeated as a hidden identifier 5b . If both parts are unencrypted, then a simple comparison of the appropriate parts of the identifier is used for verification and therefore information about the validity of the security seal.

This verification method requires no further aids or communication means and can therefore be used as a simple but powerful on-site verification.

As has already been described previously, in any case part of the identifier 5 is arranged to be hidden. This hidden arrangement is preferably to be implemented by one layer, such as the carrier 10 itself or a further layer not illustrated in the drawing, being opaque, at least in some regions, so that the hidden part of the identifier cannot be detected through it. It is very advantageous to equip the carrier 10 with an opaque layer 5c in some regions. This can be printing in the form of a coloured area or a superimposed alphanumeric symbol.

The security seal according to the invention is suitable for use as a security closure for the clear identification of an unauthorized attempt at opening or an opening for a large number of valuable or sensitive goods. One important area of application in this case is safeguarding an extremely wide range of consumer goods against theft, forgery of the content and protection against pirate copies. The unnoticed opening, theft and forgery of sensitive goods are forestalled by the application of the adhesive tapes according to the invention.

The security seals according to the invention, because of the easy internal separation over the entire area when the security seal is removed, are particularly suitable for securing the opening or the packaging of easily split paper packs or, respectively, the packaging of kraftliner cartons, although its use is not restricted thereto.

The security seals according to the invention are suitable for a large number of adhesive tape and adhesive label applications. Packaging applications are an important field of application. The security seals are suitable as carton closure tapes, general adhesive packaging tapes, strapping tapes, adhesive tapes for closing plastic packs and plastic bags and for securing pallets. Further applications are the bundling of loose goods and transport goods, such as pipes, strips of wood and so on. The adhesive closures according to the invention can be used to safeguard the transport of refrigerators and other electrical and electronic appliances, for example. Further applications are label protection, surface protection, for example in the construction sector, and tear-off strips for packs. Applications in the office sector are likewise possible.

Furthermore, applications are possible as a security closure in the packing of medical and pharmaceutical products, the securing of packs with cosmetics and body-care articles and foodstuffs and luxury foods. Likewise, an application for securing electronic and electrical appliances is possible.

Security seals according to the invention are particularly suitable for fixing to articles which are themselves configured to be opaque at the bonding point, which is the case in most articles. In this case, the article ensures that illegitimate reading of a hidden part of the identifier in the intact state of the seal is not possible from below either.

Although security seals according to the invention are preferably suitable for sealing openings of any type, it is likewise extremely advantageous to stick generic stickers on in positions in which they do not perform any sealing function. The code contained is then used merely for verification of the authenticity or of further details of the article provided with the sticker.

Applications in the area of forgery protection, grey market protection, product tracking and gaming may be mentioned by way of example as areas in which security seals can advantageously be used.

In order to manufacture security seals, in particular with a partly hidden identifier, the procedure that follows can be used, for example. A carrier material is firstly equipped with a marking layer and then, in line or offline, with the contrast layer and possibly further layers. The subsequently hidden part of the identifier can be introduced in this sequence as additional printing or as part of the layers which are in any case present, in particular the contrast layer and/or the marking layer. Recommended for this purpose are all printing and marking processes which offer the possibility of generating a large number of different numbers. Laser-based processes are conceivable in this sense, such as for example those in which, by means of the use of suitable additives, a colour change can be produced in at least one of the layers present in the product. Relief printing processes are likewise conceivable, as are planographic and gravure processes. Particularly advantageously, digital printing and inkjet printing can be used for this purpose. The manufacturing process of the security seal additionally includes the procedure of applying the adhesive compound. The adhesive layer is preferably covered by a material with release properties, or has already been covered therewith, depending on the manufacturing sequence. This material can be punched, freed from the punching waste and cut to form rolls, if the intention is to manufacture labels.

In order to complete the security seal, the hidden part of the identifier is preferably read by machine, the data are transferred into a database, supplemented there by suitable software by the exposed part of the identifier (to this end, the software can carry out appropriately suitable algorithms to generate the complete identifier), and the remaining digits of the identifier are applied to the upper side of the security seal as the exposed part of the identifier. For this last-named step, all printing and marking processes which offer the possibility of generating a large number of different numbers are recommended once again. Laser-based processes are conceivable in this sense, such as for example those in which, by means of the use of suitable additives, a colour change can be produced in at least one of the layers present in the product. Relief printing processes are likewise conceivable, as are planographic and gravure processes. Particularly advantageously, digital printing and inkjet printing can be used for this purpose. Thermal transfer printing can also very advantageously be used. The reading of the hidden part of the identifier, preferably by machine, is carried out for example through the adhesive layer or through the carrier. Depending on the variant, the layers to be transilluminated for the purpose of reading are configured in such a way that optical signals are transmitted with adequate intensity and quality. If reading is carried out through the adhesive layer, the carrier can then already be opaque or configured to be opaque. Such security seals are then preferably used on opaque adhesive backgrounds. If reading is carried out through the carrier, then the reading process is followed by yet another step, in which an opaque region is applied to the security seal above the hidden part of the identifier.

By means of the specific division of the identifier into an exposed and a hidden part, on the one hand, and the preferred introduction of the exposed part above and the hidden part below the carrier, on the other hand, and, since information can be introduced retrospectively into the interior of a multilayer structure only with very great difficulty, the present security seals are very difficult to reconstruct and forge. This advantageous property distinguishes security seals according to the invention for example from security labels which contain the identifier in full on the upper side of their carrier and part of the identifier or else the entire identifier is covered by a rub-off ink, for example.

1. Multilayer security seal comprising a carrier and an adhesive layer arranged on the entire area underneath the carrier,
the following layers being arranged between carrier and adhesive layer in any case:
a) a first layer—marking layer—not applied to the entire area
b) a second layer—contrast layer—applied to the entire area
wherein an individual identifier is contained for the purpose of verification.

2. Multilayer security seal according to claim 1, wherein the individual identifier for the purpose of verification can at least partly be detected as exposed and is at least partly configured so as to be hidden.

3. Multilayer security seal according to claim 2, wherein the exposed part of the individual identifier is arranged above the carrier and the hidden part of the identifier is arranged underneath the carrier.

4. Multilayer security seal according to claim 2, wherein the hidden part of the identifier and the exposed part of the identifier are correlated with each other.

5. Multilayer security seal according to claim 4, wherein at least part of the exposed identifier is identical to at least part of the hidden identifier and/or wherein at least part of the hidden identifier supplements, in particular completes, at least part of the exposed identifier.

6. Multilayer security seal according to claim 1, wherein the individual identifier is machine-readable.

7. Multilayer security seal according to claim 1, wherein the marking layer is arranged above the contrast layer.

8. Multilayer security seal according to claim 1 wherein the marking layer contains a fluorescent dye.

9. Multilayer security seal according to claim 1, wherein the marking layer contains an additional identifier and/or the hidden part of the individual identifier.

10. Multilayer security seal according to claim 1, wherein the individual identifier and/or the additional identifier are formed and arranged in such a way that they are not visible without aids and/or with the naked eye.

11. Multilayer security seal according to claim 1, wherein the identifier can be read only by machine.

12. Multilayer security seal according to claim 1, wherein in any case part of the identifier is encoded.

13. Multilayer security seal according to claim 1, wherein the identifier has a 1-dimensional bar code or a 2-dimensional matrix code.

14. Multilayer security seal according to claim 1, wherein the identifier has a hologram, in particular a computer-generated hologram.

15. Multilayer security seal according to claim 1, wherein it is formed as a security label.

16. Multilayer security seal according to claim 1, wherein it is formed as an adhesive tape.

17. Multilayer security seal according to claim 14, wherein the adhesive tape has a plurality of individual identifiers, preferably at regular intervals.

18. Method for the verification of the intactness of a pack, comprising the steps of
securing a pack with a multilayer security seal formed in accordance with claim 1,
inspecting the intactness of the security seal, verfifying the security seal with respect to its authenticity.

19. Method according to claim 18, further comprising the step of reading and verfifying the individual identifier.

20. Method according to claim 19, further comprising the step of decrypting the individual identifier and/or comparing the individual identifier with a reference value for verification.

21. Method according to claim 20, further comprising the step of reading the reference value from the security seal.

22. Method according to one of claims 18, further comprising the step of reading an identifier from the marking layer.

23. Method according to one of claims 18, further comprising the step of
checking the intactness of the security seal, opening the security seal and
checking a hidden part of the individual identifier for a valid correlation with an exposed part of the identifier, wherein the steps are performed in the stated sequence.

24. Method according to claim 23, wherein the complete identifier is verified by means of comparison with a database.

25. Method according to one of claims 18, wherein the verification of the security seal is carried out automatically.

26. Method according to one of claims 25, wherein the automatic verification of the security seal is carried out such that when an in authentic security seal is present, a signal is given and/or the affected pack is sorted out.
